(19) United States
(12) Patent Application Publication
(10) Pub. No.: US 2026/0103070 A1
(43) Pub. Date: Apr. 16, 2026

(54) ELECTRIFIED TRANSFER CASES GEARBOX ARCHITECTURE

(71) Applicant: Magna Powertrain of America, Inc., Troy, MI (US)

(72) Inventors: Jeffrey Botticello, Clawson, MI (US); Alexander Sandstrom, Oakland Township, MI (US); Franklin Ponnudurai, Troy, MI (US); Shawn Donaldson, Waterford, MI (US); Brendan Conneely, Ogden, UT (US)

(21) Appl. No.: 19/353,923

(22) Filed: Oct. 9, 2025

Related U.S. Application Data
(60) Provisional application No. 63/705,813, filed on Oct. 10, 2024.
(60) Provisional application No. 63/780,530, filed on Mar. 31, 2025.

(51) Int. Cl. B60K 17/346; B60K 6/365; B60K 6/387; B60K 6/52

(52) U.S. Cl. CPC B60K 17/3462; B60K 6/365; B60K 6/387; B60K 6/52

(57) ABSTRACT

A transfer case for use in a motor vehicle having a powertrain and first and second drivelines includes an input shaft, a mainshaft fixed for rotation to an input shaft, a first output shaft adapted to deliver drive torque to a first driveline, and an electric motor including a rotor shaft that drives a torque multiplying gearset. A controllable input clutch assembly is disposed between the input shaft and the rotor shaft. A controllable mode selector assembly including a carrier shift collar and a shift plunger is disposed around the output shaft between the torque multiplier and mainshaft, respectively. The carrier shift collar selectively connects and disconnects the torque multiplying gearset to the first output shaft and the shift plunger selectively connects and disconnects the mainshaft to the first output shaft.

### CROSS-REFERENCE TO RELATED APPLICATIONS

This application claims the benefit of previously filed U.S. Provisional Patent Application Nos. 63/705,813, filed Oct. 10, 2024, and 63/780,530, filed Mar. 31, 2025, the entire content of each being incorporated by reference in their entirety.

### FIELD

The present disclosure relates to a hybrid vehicle utilizing an electrified transfer case to selectively distribute power provided by an internal combustion engine and the electric motor, included in the electrified transfer case, to a primary and secondary driveline. The electrified transfer case includes multiple modes and transitions dependent on the operational condition of an input clutch assembly and a mode selector assembly. The mode selector assembly includes an arrangement of independent axially moving members to improve shift performance between modes without reduction of power provided to the driveline. The modes include, at least, modes to provide a power split to a front and/or rear axle with propulsion from a single or combined power source, selectively increased by a planetary ratio, as well as modes to allow the vehicle to be flat towed or generate power to recharge a battery.

### BACKGROUND

This section provides background information related to the present disclosure which is not necessarily prior art.

Automobile manufacturers are actively working to develop alternative powertrain systems in an effort to reduce the level of pollutants exhausted into the air by conventional powertrains equipped with internal combustion engines. Hybrid vehicles are equipped with an internal combustion engine and an electric motor that can be operated independently or in combination to drive the vehicle. Significant development has been directed to these hybrid electric vehicles, but often require a significant modification to the existing powertrain. Hybrid vehicles have been adapted to be used in all-wheel drive or four-wheel drive vehicles with most systems on the market being a P2 hybrid arrangement, where an electric motor is located between the internal combustion engine and a multi gear transmission in a longitudinal arrangement. A transfer case is located at the rear of the transmission to direct power to a primary rear axle and a secondary front axle. Other alternatives include integrating a single motor or dual motors into a multispeed transmission and retaining the standard transfer case to split power between the primary and secondary axle. Implementing a P2 hybrid system with an existing transmission or developing a new hybrid transmission and combining with a traditional four-wheel drive system may be extremely expensive and difficult to package due to additional length. Thus, a need exists to develop hybrid powertrains for use in four-wheel drive vehicles that utilize many conventional powertrain components, so as to minimize specialized packaging and reduce cost. As will be shown, the electrified transfer case also provides additional operating modes not available in conventional hybrid powertrains.

### SUMMARY

This section provides a general summary of the many aspects associated with the inventive concepts embodied in the teachings of the present disclosure and is not intended to be considered a complete listing of its full scope of protection nor all of its features and advantages.

In one form, an electrified transfer case for a vehicle having an engine, a transmission, and front and rear drivelines is provided. The electrified transfer case includes a first output shaft adapted for connection to the rear driveline, a second output shaft adapted for connection to the front driveline, and an input shaft connected to the output of the transmission. The transfer case can further include a gear set engaged to an electric motor for torque multiplication, a clutch to connect the input to the electric motor rotor shaft, a multi position torque transferring mode connection system, and a controllable torque transfer system between the first output shaft and the second output shaft. The torque transfer system may be a chain or gear drive, with the controllable multiplate clutch selectively providing power to the second output shaft and front driveline. The electrified transfer case may have six primary modes. The modes include an electrical only driven mode, an internal combustion engine mode, a hybrid mode where engine torque is provided in a 1:1 relationship and a second hybrid mode where engine torque is multiplied by the ratio of a gear set. The modes further includes a neutral flat tow mode, with no connection between the input of the electrified transfer case to the front and rear output shafts, and a generator mode, where the electric motor, powered by the engine, may replenish a depleted battery while the vehicle is stationary. Further secondary modes may be achieved via actuation of a controllable clutch to provide torque distribution between the front and rear axles to provide a 2WD, an AWD variable mode, or a locked clutch 4WD mode or controlling of the electric motor to provide regeneration to a battery.

In another form, a hybrid vehicle is provided. The hybrid vehicle can include a powertrain, first and second drivelines and the electrified transfer case of the present disclosure. The powertrain can include an internal combustion engine and an electric motor as motive power sources. The first driveline may transfer power to a first set of ground engaging wheels. The second driveline may transfer power to a second set of ground engaging wheels. The electrified transfer case may include first and second output shafts and an input shaft. The first output shaft may be adapted for connection to the first driveline and the second output shaft may be adapted for connection to the second driveline. The input shaft may be adapted for connection to the output of a transmission powered by an internal combustion engine. The electrified transfer case is provided as described above and provides the ability for the hybrid vehicle to operate in various modes depending on the position of the input clutch assembly, the mode selection device and the controllable clutch assembly.

These and other features and advantages of the present disclosure will become more readily appreciated when considered in connection with the following detailed description and drawings.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 is a schematic of a hybrid drive system for a four-wheel drive vehicle in accordance with the teachings of the present disclosure;

FIG. 2 is a cross section of a first embodiment of an electrified transfer case of the present disclosure;

FIG. 3 is a detailed view of the input clutch assembly, mode selector assembly, electric motor, and planetary of an electrified transfer case;

FIG. 4 is a cross-sectional isometric view of the mode selector assembly;

FIG. 5 shows the power flow of a neutral mode, providing disconnection from the ground engaging wheels;

FIG. 6 shows the power flow of a generator mode, providing the ability to use the electric motor driven by the internal combustion engine to generate power and/or charge the onboard battery;

FIG. 7 shows the power flow of an electric operating mode, providing propulsion from an electric motor;

FIG. 8 shows the power flow of hybrid low operating mode, providing combined torque from the electric motor and an ICE, the combined torque multiplied by the planetary;

FIG. 9 shows the power flow of a hybrid high operating mode, providing torque from an electric motor multiplied by the ratio of the planetary, with the multiplied torque from the electric motor combined with the torque from the ICE; and

FIG. 10 shows the power flow of an ICE only propulsion mode.

### DETAILED DESCRIPTION

The following description is exemplary in nature and is not intended to limit the present disclosure, application, or uses.

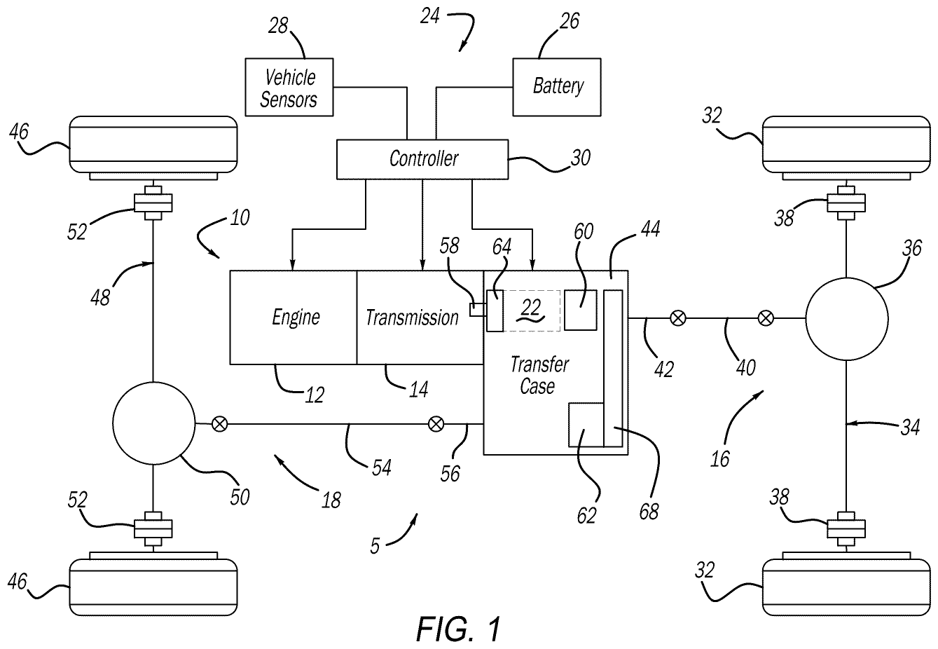

Referring to FIG. 1 of the drawings, a hybrid powertrain system 5 for a hybrid motor vehicle is shown and can include a first power source 10, a transmission 14, a rear driveline 16, a front driveline 18, and a second power source 22. The first power source may include an internal combustion engine 12 and the second power source may include an electric motor/generator 22. Transmission 14 can be of any known type including, but not limited to, an automatic, manual, automated manual or continuously variable transmission. The vehicle can further include a powertrain control system 24 generally shown to include a battery 26, a group of vehicle sensors 28, and a controller 30. Rear driveline 16 can include a first pair of wheels 32 connected to a rear axle assembly 34 having a differential unit 36 and a pair of rear axle or wheel disconnects 38. Differential unit 36 can be connected to one end of a rear prop shaft 40, the opposite end of which can be connected to a first or rear output shaft 42 of a transfer case 44. Similarly, front driveline 18 can include a second pair of wheels 46 connected to a front axle assembly 48 having a differential unit 50 and a pair of wheel disconnects 52. Alternatively, a center axle disconnect may be provided in place of wheel disconnects 38 and 52 to achieve similar functionality. Differential unit 50 can be connected to one end of a front prop shaft 54, the opposite end of which can be connected to a second or front output shaft 56 of electrified transfer case 44. The hybrid four-wheel drive powertrain system 5 of the present disclosure can include two main power sources, namely internal combustion engine 12 and electric motor/generator 22. Power from engine 12 can be transmitted to transmission 14, which in turn, can be delivered to transfer case 44 via input shaft 58. Control system 30 can be provided for controlling operation of the hybrid four-wheel drive powertrain system 5. Based upon the operating information inputted to controller 30, a mode of operation of the electrified transfer case 44 can be selected and controller 30 can send electronic control signals to the various power-operated controlled devices. Specifically, controller 30 can monitor and continuously control actuation of motor/generator 22, engagement of front and rear wheel disconnects 52, 38 if present, operation of mode selector assembly 60, operation of controllable clutch assembly 62, and operation of input clutch assembly 64.

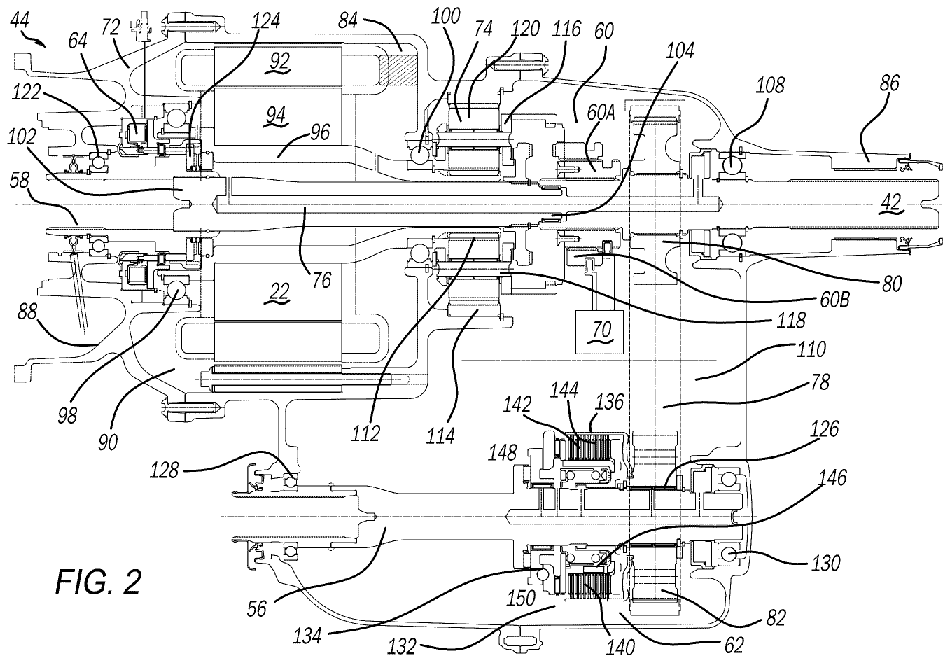

Referring now to FIG. 2, electrified transfer case 44 is shown including an electric motor 22, a gear reduction assembly 66 in the form of a planetary arrangement multiplying torque from electric motor 22 to a power transferring device 68 depending on the states of a mode selector 60 and input clutch 64. Mode selector assembly 60 in this embodiment is located concentric to the input shaft 58 and includes a carrier shift collar 60A and a shift plunger 60B. The carrier shift collar 60A and shift plunger 60B may be shifted via an actuator 70. An input clutch assembly 64, to selectively connect electric motor 22 to the input shaft 58 and shifted via an actuator 72. Actuator 70 and 72 may be a single or multiple actuators of electromechanical, electromagnetic, or other type capable of moving carrier shift collar 60A, shift plunger 60B, and input clutch assembly 64 in a controlled manner through the required axial positions based on commands from controller 30. Depending on the positions of mode selector assembly 60, controllable clutch assembly 62, and input clutch assembly 64, power is provided to rear output shaft 42 and/or front output shaft 56 via different power paths.

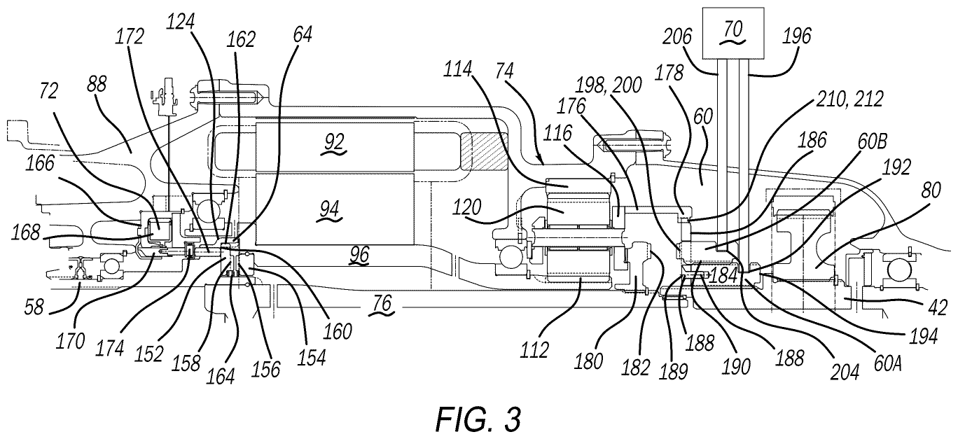

The overall layout of electrified transfer case 44 will be described with reference to FIG. 2 and be further described in detail with reference to FIG. 3. Located concentrically with input shaft 58 about a first axis are the input clutch assembly 64, electric machine 22, planetary gear assembly 74, mode selector 60, mainshaft 76, and rear output shaft 42. On a parallel offset second axis, controllable clutch assembly 62 is provided. Power transferring device 68 is provided in the form of a chain 78 to transfer power from the rear output shaft 42 to the front output shaft 56 via a drive sprocket 80 (attached to the rear output shaft 42) and driven sprocket 82 (attached to controllable clutch assembly 62) depending on the state of controllable clutch assembly 62. Electrified transfer case 44 includes a main housing 84, a rear housing 86, and a cover 88 used to enclose and support the internal components. Main housing 84 receives electric motor 22 into motor cavity 90. Electric motor 22 includes a stator 92 fixed to the main housing 84. Electric motor 22 is commanded by controller 30. A rotor assembly 94 of electric motor 22 is located radially inward from stator 82 and includes a hollow rotor shaft 96. Rotor shaft 96 is supported via a first rotor shaft bearing 98 and a second rotor shaft bearing 100 allowing rotation relative to the housings and stator 82. First rotor shaft bearing 98 is installed into cover 88 while second rotor shaft bearing 100 is installed into main housing 84. Passing through the hollow portion of rotor shaft 96 is mainshaft 76. Mainshaft 76 is fixedly coupled to input shaft 58 on a first end 102 and supported by rear output shaft 42 via pilot bearing 104 on a second end 106. Rear output shaft 42 is further supported by bearing 108 in main housing 84. Main housing 84 will also receive planetary gear assembly 74 in cavity 110. Planetary assembly 74 includes a sun gear 112 formed integrally on rotor shaft 96, a ring gear 114 rotatably fixed to main housing 84, a carrier unit 116 having a plurality of pins 118, and a plurality of planet gears 120 each rotatably mounted (via a bearing assembly) on a corresponding one of the pins 118, and which are each in constant meshed engagement with sun gear 112 and ring gear 114, providing an increased ratio, multiplying the torque provided by electric motor 22. Cover 88 closes off motor cavity 90 and provides support for input shaft 58 via bearing 122. Input clutch assembly 64 is located within the motor cavity 90 and is arranged radially about input shaft 58,. Input clutch assembly 64 includes actuator 72 and clutch 124, where clutch 124 is used to provide a selectable connection between the input shaft 58 and the rotor shaft 96.

Dependent on the connection state of mode selector assembly 60, including carrier shift collar 60A and a shift plunger 60B, power may be provided to drive sprocket 80, which is transferred to chain 78, causing driven sprocket 82 to rotate. Driven sprocket 82 is supported on and allowed to rotate relative to front output shaft 56 by bearing 126. This allows driven sprocket 82 to rotate relative to front output shaft 56, unless controllable clutch assembly 62 is activated. Front output shaft 56 is supported for rotation relative to main housing 84 via bearing 128 and relative to rear housing 86 via front output rear bearing 130. Driven sprocket 82 is rotatably fixed to friction clutch assembly 132 of controllable clutch assembly 62. The controllable clutch assembly 62 is provided to actively control the power provided from driven sprocket 82 (which receives power from rear output shaft 42 and drive sprocket 80) to front output shaft 56. Controllable clutch assembly 62, in this non-limiting example, is a wet-type friction clutch assembly 132 disposed between driven sprocket 82 and front output shaft 56 for facilitating adaptive torque transfer therebetween. Controllable clutch assembly 62 is actuated by clutch actuation device 134. Friction clutch assembly 132 generally includes a first clutch member or clutch drum 136 fixed for common rotation with driven sprocket 82, a second clutch member or clutch hub 138 mounted to, or formed integrally with, an intermediate section of front output shaft 56, and a multi-plate clutch pack 140 comprised of alternatively interleaved outer clutch plates 142 and inner clutch plates 144. Outer clutch plates 142 are splined for rotation with clutch drum 136 while inner clutch plates 144 are splined for rotation with clutch hub 146. Inner clutch plates 144 may alternatively be directly splined to front output shaft 56 with hub 146 eliminated. Controllable clutch assembly 62 is best shown, in the non-limiting example of FIG. 2, to include a motor-driven rotary-to-linear conversion device of the type commonly referred to as a ballramp unit. The ballramp unit generally includes a first cam ring 148, a second cam ring 150, and disposed in aligned cam tracks formed therebetween. First cam ring 148 is non-rotatably fixed to rear housing 86 via an anti-rotation feature. An electric actuator is utilized, based on input from controller 30, to drive and rotate second cam ring 150 and, as a result of rotation of second cam ring 150 relative to first cam ring 148, a resultant axial travel and force is provided against friction clutch assembly 132. The electric actuator may be controlled to vary rotation, and therefore pressure on friction clutch assembly 132 to vary the amount of torque transferred to front output shaft 56.

While controllable clutch assembly 62 is shown preferably configured as a multi-plate wet-type friction clutch assembly 132 actuated by a ball ramp, those skilled in the art will recognize that such a mechanism is intended to represent any type of actively-controlled torque transfer clutch or coupling capable of selectively coupling front output shaft 56 for rotation with driven sprocket 82 for facilitating the transfer of drive torque to front driveline 18. Other rotary-to-linear conversion devices (i.e., ballscrew units), camming devices or pivotable devices configured to control the magnitude of the clutch engagement force applied to friction clutch assembly 132 are considered alternatives for controllable clutch assembly 62. Providing controllable clutch assembly 62 on the front output shaft 56 results in reduced axial packaging requirements of electrified transfer case 44.

Referring to FIG. 3, further details of input clutch assembly 64 and mode selector assembly 60, including carrier shift collar 60A and a shift plunger 60B positioned about the first axis, will be provided. Input clutch assembly 64 includes actuator 72 and clutch 124, where clutch 124 is used to provide a selectable connection between input shaft 58 and rotor shaft 96. Input clutch 124 is shown as an axially engaging dog clutch, with an input clutch member 152 and a rotor clutch member 154. Rotor clutch member 154 is shown as a separate component fixed to rotor shaft 96, via weld or other mechanical attachment method. Rotor clutch member 154 includes a plurality of axially extending clutch teeth 156 facing toward input clutch member 152. Alternatively, the axially extending clutch teeth 156 may be integrally formed on the rotor shaft 96. Input clutch member 152 is a ring-shaped component with a plurality of axially extending teeth 158 on the side facing toward rotor clutch member 154, with the input clutch member 152 being disposed in a pocket 160 formed in the input shaft 58. A second set of clutch teeth 162 may be positioned on the inner or outer diameter surface of the ring shape to engage to a mating spline feature on the inner walls of pocket 160 of input shaft 58. In this example these teeth are positioned on the outer wall of pocket 160 to engage on the outer diameter of input clutch member 152. Input clutch member 152 is free to axially move relative to the input shaft 58 within pocket 160 but will always be engaged to input shaft 58 and rotate with input shaft 58. This allows torque to transfer between input shaft 58 and rotor shaft 96 only when input clutch 124 is actuated to be engaged. An actuator 72 is selectively controllable to move input clutch member 152 into and out of engagement with rotor clutch member 154 based on the input of controller 30. A spring 164 positioned between input clutch member 152 and rotor clutch member 154 urges input clutch member 152 away from rotor clutch member 154 when actuator 72 is not activated. Actuator 72 in this embodiment is shown as an electromagnetic actuator or solenoid, including a housing 166 that receives a ring-shaped electromagnetic coil 168, the housing 166 received in cover 88. A plunger or armature 170 is provided in the inner portion of the coil 168 that is responsive electrical current provided to the coil 168. The plunger 170 applies force to the applicator 172 via a thrust bearing 174, because plunger 170 is rotationally stationary while input clutch member 152 is rotating with input shaft 58.

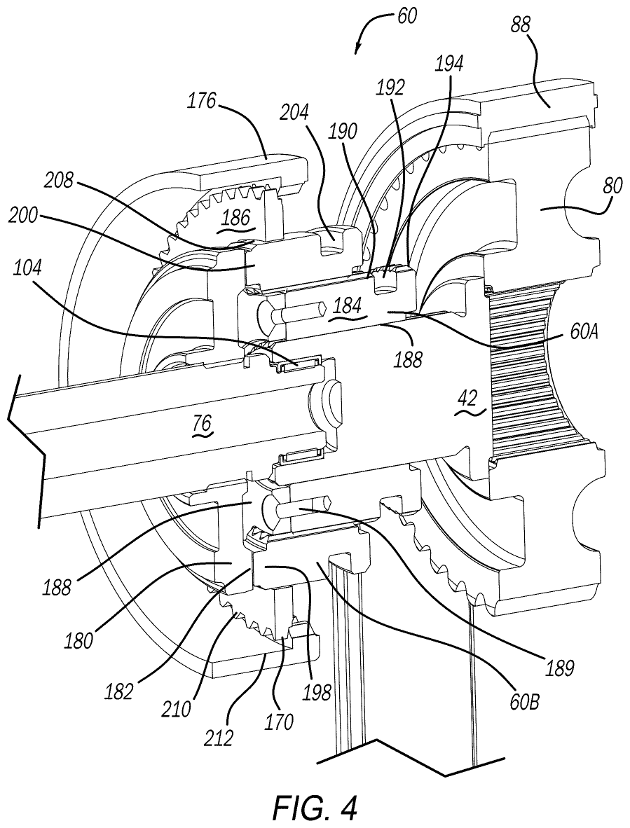

On the right side of FIG. 3, and also shown in a perspective cross-sectional view in FIG. 4, mode selector assembly 60 is shown, which allows selectable connection between planetary assembly 74, mainshaft 76, and/or rear output shaft 42. Mode selector assembly 60 includes carrier shift collar 60A and a shift plunger 60B positioned concentrically about rear output shaft 42. Planetary carrier 116 includes a ring like extension 176 with an internally extending teeth 178. Mainshaft 76 includes a radially extending flange portion 180 fixed axially and rotationally to mainshaft 76. Mainshaft flange portion 180 includes a plurality of axially extending dog teeth 182 facing toward shift plunger 60B.

Carrier shift collar 60A is constructed of a hollow collar portion 184 and a radially extending collar flange portion 186 attached to a first end 187 of collar portion 184 via fasteners 189. Collar portion 184 and flange portion 186 may also be integrally formed. Collar portion 184 includes an inner spline 188 engaging rear output shaft 42, allowing movement axially along the rear output shaft 42 but coupling the shift collar 60A and rear output shaft 42 for rotation, and an outer spline 190. A groove 192 is provided near a second end 194 of collar portion 184 to receive a shift fork 196 from actuator 70. The groove for the shift fork 196 allows actuator 70 to move carrier shift collar 60A axially along rear output shaft 42 while the output shaft 42 and collar 184 rotate. Outer spline 190 engages a mating inner spline of shift plunger 60B, allowing independent axial movement of shift plunger 60B relative to carrier shift collar 60A and rear output shaft 42. On the first end of shift plunger 60B, a plurality of arc shaped lugs 198 are included, having axially extending dog teeth 200 designed to mate with corresponding axially extending dog teeth 182 of the mainshaft flange 180 when axially shifted into engagement. Shift plunger 60B also includes a groove 204 near its second end. Groove 204 may receive a shift fork 206 from the same actuator 70, or from a separate actuation device. Actuator 70 provides independent actuation and movement of carrier shift collar 60A relative to shift plunger 60B.

As best seen in FIG. 4, flange portion 186 of carrier shift collar 60A includes arc shaped apertures 208, allowing insertion of lugs 198 of shift plunger 60B to pass through and extend past the first end 188 of carrier shift collar 60A. Carrier flange 186 also includes a plurality of radially extending teeth 210 on the outer diameter 212 of the flange. These teeth 210 may selectively engage into teeth 178 of extension 176 of carrier 116, thereby coupling rotation of planet carrier 116 to the carrier flange 186 and carrier shift collar 60A, dependent on the axial location of carrier shift collar 60A.

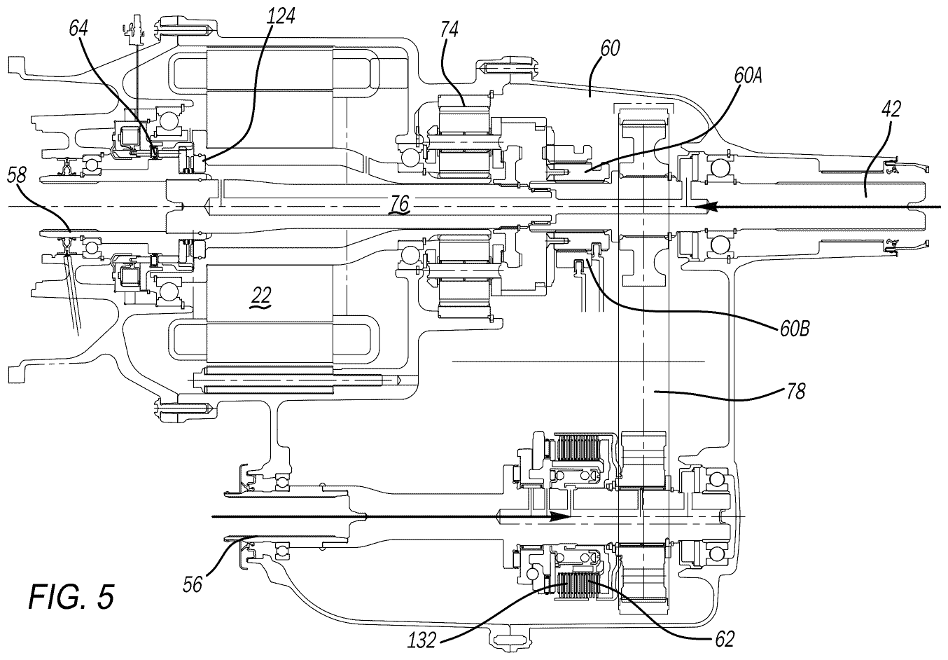

FIG. 5-10 illustrates how input clutch assembly 64 and mode selector 60A and 60B may be engaged or disengaged in this electrified transfer case 44 to provide various operating modes. Power flow through the electrified transfer case 44 is shown via bold lines and arrows and will be fully described for each mode, including a neutral or flat tow mode, a power generating mode, an electrical only mode, a hybrid low and normal hybrid ratio mode, and a traditional ICE driven mode. With each of the vehicle active driving modes, a 2WD or actively controlled 4WD functionality will also be provided.

FIG. 5 provides a flat tow operating mode providing a neutral mode of electrified transfer case 44, where mode selection device 60A and mode selection device 60B are both disengaged. Controllable clutch assembly 62 is also fully open and not actuated. In this mode, the intention is to ensure rear driveline 16 and front driveline 18 do not backdrive transmission 14 via the input shaft 58, and also do not backdrive the electric motor 22 via planetary 74. Rear output shaft 86 will be back driven by rear driveline 16, resulting in drive sprocket 80 and driven sprocket 82 rotating via chain 78, but because no positive connection is provided by either carrier shift collar 60A or shift plunger 60B, and also the connection at the controllable clutch assembly 62 is fully open, no backdriving occurs when the vehicle is towed in the forward or reverse condition. Providing a flat tow neutral mode may provide alternatives to the types of motor 22 technology used during flat tow situations, because the concern for back EMF is eliminated and it reduces the requirements of lubrication of internal components of electrified transfer case 44 because many of the components remain stationary in this mode. Input clutch assembly 64 may be engaged or disengaged in this mode with the same effect.

FIG. 5 illustrates bold arrows indicating torque being provided into the transfer case via the rotation of the front and rear drivelines, and front and rear outputs shafts 56, 42, caused by the towing. The torque in these output shafts is not transferred therebetween. The torque further does not pass from either shaft into the planetary or the mainshaft. The shift collar 60A may rotate, but each of the components that rotates with the shift collar 60A remains disengaged from any backdriven connection into the mainshaft 76 or the planetary 74 and the motor 22.

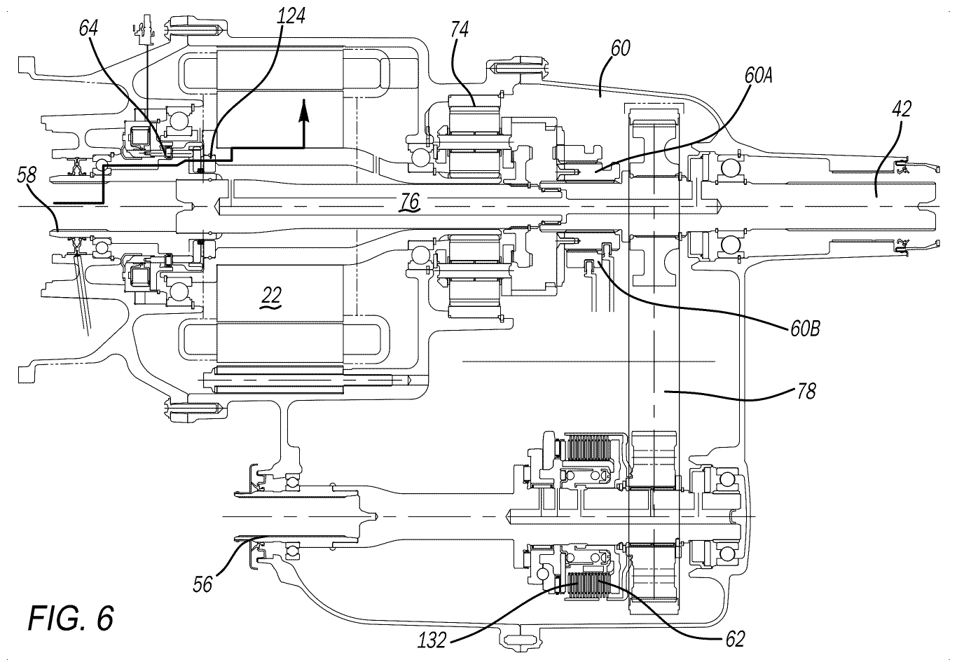

FIG. 6 shows electrified transfer case 44 in a generator operating mode. Similar to the neural mode of FIG. 5, the mainshaft 76 and motor 22 are disconnected from the output shafts and drivelines. Unlike the neutral mode illustrated in FIG. 5, the vehicle is not being towed and torque is not applied to the output shafts. The input shaft 58 and mainshaft 76 rotate and provide generative power to the motor 22.

The mode of FIG. 6 provides the potential for generating power to the electric motor 22 as driven by the engine 12 via transmission 14, with the vehicle stationary, to recharge a depleted battery or provide a power source from the vehicle to power external systems. In this arrangement, when the vehicle is stationary and in generating mode, power will be provided by the engine 12 via the transmission 14 and transfer case input shaft 58 to the electric motor 22, via a connected state of the input clutch assembly 64. Power will not be delivered to the rear driveline, because carrier shift collar 60A is shifted away from the carrier 116 and its teeth, eliminating torque transfer. Similarly, no connection is made between the mainshaft 76 and the rear output shaft 42, because shift plunger 60B is also not engaged. In this mode, only the input clutch 124 is engaged with the rotor shaft 96, thereby providing a connection for the rotor shaft 96 with the input shaft 58. Power from the engine 112 thereby rotates the electric motor rotor shaft 96. The planetary gearset 74 will also rotate, as the sun gear 112 rotates to cause rotation of the pinion gears 120, rotating carrier 118, but this rotation does not contribute to the actual power flow because the carrier 118 is not engaged with carrier shift collar 60A. It may also be possible to use this mode to start the vehicle's engine when the vehicle is stationary by powering the motor 22 and back driving the engine 12 via the transmission 14, spinning the engine 12 as a traditional starter would. The position of the carrier shift collar 60A and the plunger 60B in this mode is the same as in the neutral mode of FIG. 5. Unlike the neutral mode of FIG. 5, because power is provided from the input shaft 58, the state of the input clutch 64 is relevant to the illustrated torque flow.

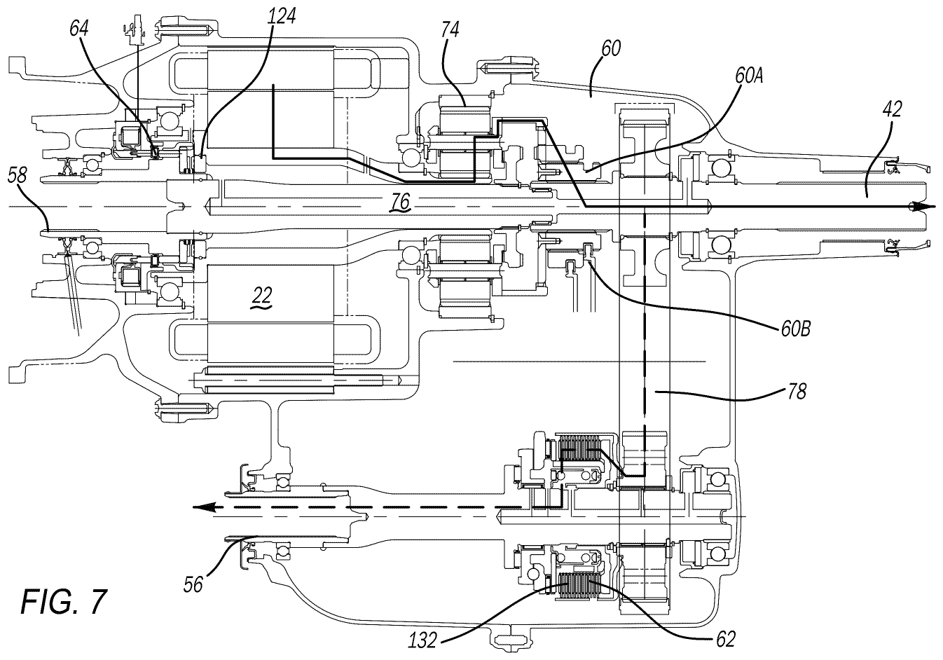

FIG. 7 shows the power flow of electrified transfer case 44 in an electric only powered mode. In this arrangement shift plunger 60B is disengaged (as in FIGS. 5 and 6) while carrier shift collar 60A is engaged, providing connection between the carrier 116 and the rear output shaft 42, and the input clutch assembly 64 at the left side of FIG. 7 is disengaged. Because there is no connection made between the electric motor 22 and the input shaft 58 and the engine 12 is not providing power, the input shaft 58 and mainshaft 76 are stationary. Torque delivered by the motor 22 is increased by the ratio of the planetary 74. The sun gear 112 drives planet gears 120 which in turn drive the planetary carrier 116 with an increased ratio while the ring gear 114 is held stationary. The power from the motor 22 and planetary 74 is delivered to the rear output shaft 42 via the carrier shift collar 60A because it is shifted to be engaged to the carrier 116 and the rear output shaft 42 via the spline teeth 188, as previously described. The electric motor 22 may also operate in a regeneration mode here, particularly when the vehicle is slowing recouping energy to be supplied back to the battery 26.

Dependent on the operational state of controllable clutch assembly 62, the power provided by electric motor 22 may be distributed fully to rear output shaft 42 and rear axle 34 to provide a 2WD mode or, with a variable force applied by clutch actuator device 134 to frictional clutch 132, torque may also be controllably distributed to the front output shaft 56 and front axle 48, providing an all-wheel or four wheel drive operating condition operating condition. Whether controllable clutch 62 is engaged or not, drive sprocket 80 and driven sprocket 82 will rotate along with rotation of rear output shaft 42.

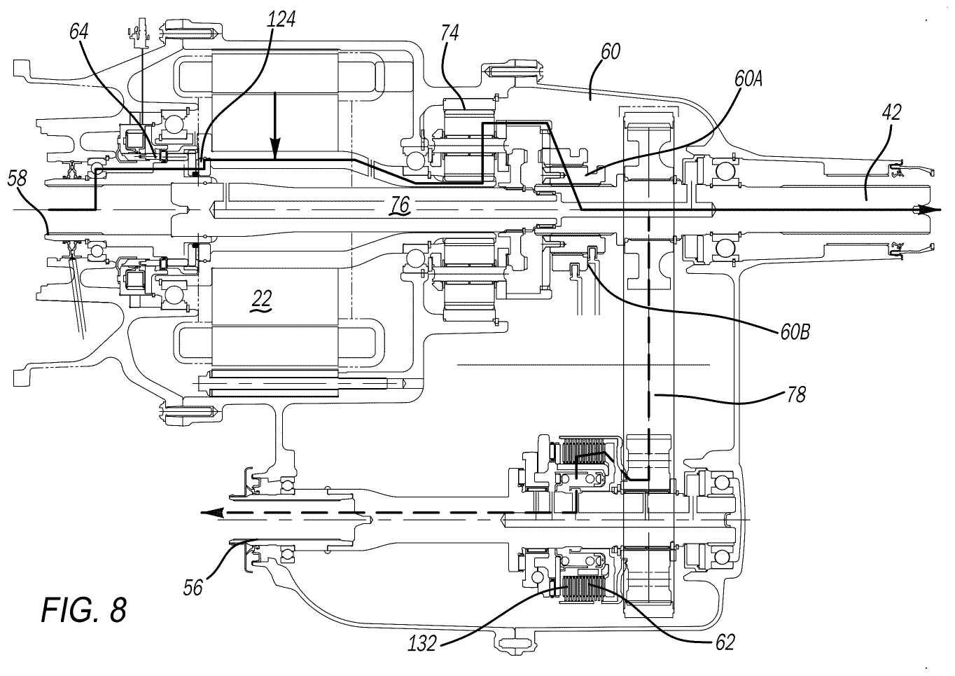

FIG. 8 shows the power flow of electrified transfer case 44 in a low ratio hybrid operating mode. In this arrangement power is provided by the engine 12 via the transmission 14 to the transfer case input shaft 58, and the electric motor 22 provides further power. This combination of the torque provided by the engine 12 and the electric motor 22 are both increased together via the planetary 74. The combined power is delivered to the rear driveline 16 via the rear output shaft 42 and may also be distributed to the front driveline 18 via the frictional clutch 132. In this mode, the input clutch 64 is engaged with the rotor shaft 96, and the carrier shift collar 60A is engaged with the planetary. The shift plunger 60B is disengaged.

In this mode, input clutch assembly 64 is engaged with the rotor shaft 96 providing a connection with the input shaft 58 via clutch 124. Power from the engine 12 is combined with power from the electric motor 22 via the rotor shaft 96. Torque delivered by both the engine 12 and the motor 22 is increased by the ratio of the planetary 74, because the rotor shaft 96 and integrated sun gear 112 will drive planets 120, which in turn drives the planetary carrier 116 with an increased ratio while the ring gear 114 is held stationary. The power will be delivered to the rear output shaft 42 via the carrier shift collar 60A, because carrier shift collar 60A is engaged to the carrier 116 and the rear output shaft 42 via the spline teeth 188, as previously described. The electric motor 22 may also operate in a regeneration mode, particularly when the vehicle is slowing recouping energy to be supplied back to the battery. A low ratio operating mode where power from the engine 12 and the motor 22 is combined is beneficial for maximum tractive effort and providing the ability to improve throttle fidelity in off roading conditions. Further tractive capability may be provided based on the operational state of controllable clutch assembly 62. The variable force applied by clutch actuator device 134 to frictional clutch 132 may controllably distribute the combined power to the front output shaft 56 and front axle 48, providing an all-wheel or four-wheel drive operating condition operating condition.

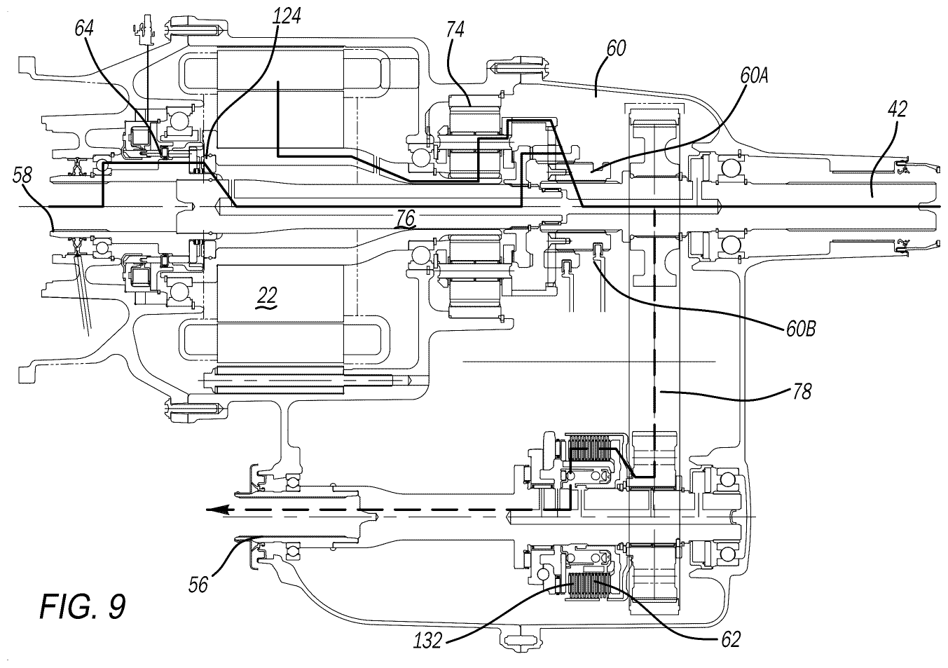

FIG. 9 shows the power flow of electrified transfer case 44 in a high ratio hybrid operating mode. In this mode, the input clutch 64 is disengaged, the carrier shift collar 60A is engaged with the planetary 74, and shift plunger 60B is engaged with the mainshaft flange 180.

In this arrangement power is provided by the engine 12 via the transmission 14 to transfer case input shaft 58 while electric motor 22 provides power via the planetary 74. The power from each is combined together by the mode selector assembly 60 components to the rear output shaft 42. Engine power 12 is delivered directly to the rear output shaft 42 via the activation of the shift plunger 60B in a 1:1 ratio, while the electric motor 22 power is provided to the rear output shaft 42 via the ratio of the planetary assembly 74 and carrier shift collar 60A. The electric motor 22 power transfer through the planetary 74 and to the rear output shaft 42 via the carrier shift collar 60A is the same as described in the low ratio operation. Unlike the low ratio operation, the input clutch assembly 64 is in a disconnected, non-torque transferring position. In this mode of FIG. 9, to transfer engine power from the input shaft 58 to the rear output shaft 42, the shift plunger 60B is shifted toward the mainshaft flange 180 into engagement via actuator 70. The axially extending dog teeth 200 of the shift plunger 60B mate with axially extending dog teeth 182 of the mainshaft flange 180. The motor 22, in this mode, may be operated in a powered mode, a generating mode, or a non-powered mode where only engine 12 power is provided to the front 18 and rear 16 drivelines depending on the input of controller 30. Dependent on the operational state of controllable clutch assembly 62, the power provided by engine 12 and/or electric motor 22 to the rear output shaft 42 may be distributed fully to rear output shaft 42 and the rear axle 34 to provide a 2WD mode or, with a variable force applied by clutch actuator device 134 to frictional clutch 132, torque may also be controllably distributed to the front output shaft 56 and front axle 48, providing an all-wheel or four wheel drive operating condition operating condition.

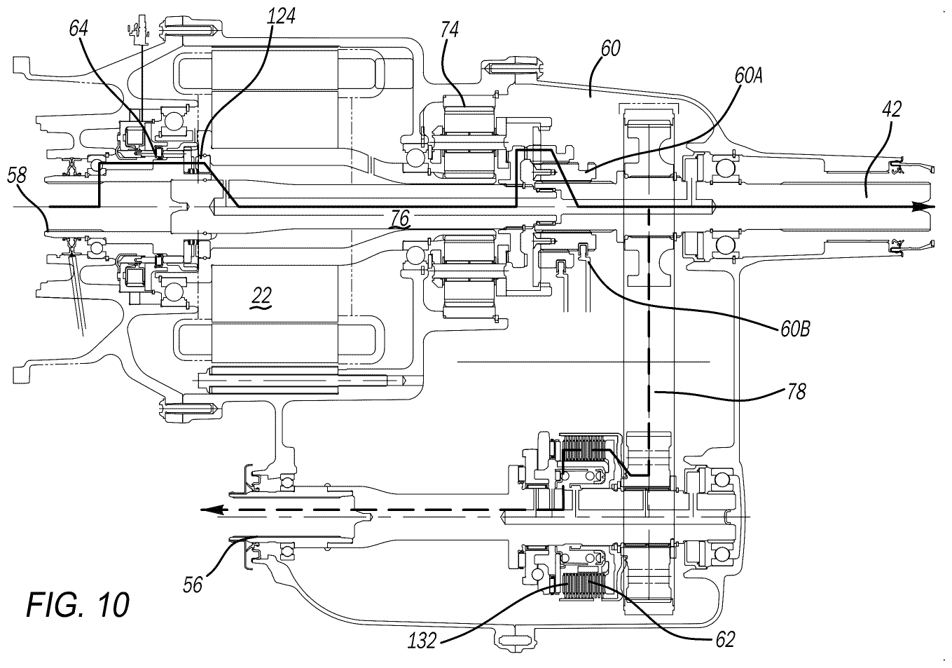

FIG. 10 provides a conventional operating mode of the electrified transfer case 44, where only the internal combustion engine 12 provides the source of propulsion for hybrid powertrain vehicle. Both input clutch assembly 64 and the carrier shift collar 60A are provided in a disconnected position, while shift plunger 60B is in a connected position (as in FIG. 9). In this mode, input clutch 124 and planetary assembly 74 are not engaged, to prevent backdriving of electric motor 22. A positive power providing connection is made from input shaft 58 and mainshaft 76 via the mainshaft flange 180 to the shift plunger 60B, and then onto rear output shaft 42 via collar body 184 and spline 188 based on the rotationally fixed engagement between the shift plunger 60B and the carrier shift collar 60A. Internal combustion engine 12, via transmission 14, transmits power into electrified transfer case 44 via the power path described. Dependent on the operational state of controllable clutch assembly 62, the power provided by engine 12 may be distributed fully to rear output shaft 42 and rear axle 34 to provide a 2WD mode or, with a variable force applied by clutch actuator device 134 to frictional clutch 132, torque may also be controllably distributed to the front output shaft 56 and front axle 48 providing an all-wheel or four wheel drive operating condition operating condition.

The arrangement of the mode selector assembly 60 that allows for controlled independent movement of the carrier shift collar 60A and shift plunger 60B improves shift performance when transitioning between modes. It is beneficial to utilize this arrangement because it will reduce or prevent situations where axial movement of the carrier shift collar 60A and/or shift plunger 60B may not be completed due to misalignment of splines and teeth or significant torque binding between splines and teeth while power is being transferred via one of the connection paths. If shift collar 60A and shift plunger 60B were one component while still maintaining the same number and type of operating modes, surrounding components would become more complex, interrupt power transfer during mode changes, and the likelihood of a blocked or incomplete shift would increase. As an example, when transitioning between Hybrid 4LO and Hybrid HI operating modes, carrier shift collar 60A may remain engaged, providing power transfer from electric motor 22 and engine 12 via carrier 116 to rear output shaft 42 to continually propel the vehicle. As the mode transitions, shift plunger 60B is engaged resulting in engine power to be directly driven from the mainshaft 76 to rear output shaft 42 without the multiplication of planetary 74. Controlling movement of shift plunger 60B can be done in a manner by actuator 70 to ensure engagement between axially extending clutch teeth 182 and 188 is achieved even when torque is being transferred via carrier shift collar 60A. When moving from Hybrid HI to ICE mode, carrier shift collar 60A is axially displaced by actuator 70 while maintaining the position and engagement of shift plunger 60B, allowing power to be transferred from a combination of electric motor 22 and engine 12 to solely engine 12 as electric motor 22 power is reduced and carrier shift collar 60A is disengaged from carrier 116 without vehicle 5 stopping. Actuator 70 may include a spring applied system which will allow full travel of the actuator even if a blocking of engagement between teeth or splines occur. Once the block is “cleared” or the teeth are able to align, the spring internal to actuator 70 will allow the movement of shift plunger 60B or carrier shift collar 60A to be completed providing full engagement.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of disclosure.

1. A transfer case for use in a motor vehicle having a powertrain and first and second drivelines, comprising:
an input shaft;
a mainshaft fixed for rotation to an input shaft;
a first output shaft adapted to deliver drive torque to a first driveline;
an electric motor including a rotor shaft that drives a torque multiplying gearset;
a controllable input clutch assembly disposed between the input shaft and the rotor shaft and controllable to selectively connect and disconnect the input shaft to the rotor shaft for torque transfer therebetween;
a controllable mode selector assembly including a carrier shift collar and a shift plunger, wherein the carrier shift collar and the shift plunger are independently controllable and axially shiftable relative to each other;
wherein the carrier shift collar selectively connects and disconnects the torque multiplying gearset to the first output shaft and
wherein the shift plunger selectively connects and disconnects the mainshaft to the first output shaft.

2. The transfer case of claim 1, further comprising:
a second output shaft adapted to deliver drive torque to a second driveline;
a power transferring device connecting the first output shaft and second output shaft;
a controllable clutch assembly positioned between the first output shaft and the second output shaft that, when engaged, transfers torque from the first output shaft to the second output shaft via the power transferring device.

3. The transfer case of claim 2, wherein the controllable clutch assembly provides a variable clutch engagement force and adjusts the amount of torque transfer to the second output shaft based on the clutch engagement force.

4. The transfer case of claim 1,
wherein the input clutch assembly includes an axially shiftable input clutch that is rotationally fixed to the input shaft and includes axially extending input clutch teeth;
wherein the rotor shaft includes axially extending rotor clutch teeth rotationally fixed thereto;
wherein the input clutch includes an axially moveable applicator that axially shifts the input clutch and the input clutch teeth into engagement with the rotor clutch teeth to selectively connect the input shaft to the rotor shaft for torque transfer therebetween.

5. The transfer case of claim 1, wherein the carrier shift collar and the shift plunger are rotationally fixed relative to the each other.

6. The transfer case of claim 5,
wherein the carrier shift collar includes a collar portion and a flange portion fixed thereto;
wherein the collar portion is rotationally fixed to the first output shaft and axially shiftable relative to the first output shaft.

7. The transfer case of claim 6, wherein the flange portion includes at least one aperture, wherein a lug portion of the shift plunger is inserted through the at least one aperture and extends beyond the flange portion.

8. The transfer case of claim 7, wherein the mainshaft includes a radially extending main shaft flange having axially extending dog teeth, wherein the axially extending dog teeth are aligned with corresponding axial dog teeth extending from the lug portion, wherein the shift plunger is axially shiftable into engagement with the mainshaft flange.

9. The transfer case of claim 6, wherein the flange portion of the carrier shift collar includes teeth that are axially shiftable into engagement with a carrier of the torque multiplying gearset to transfer torque between the first output shaft and the torque multiplying gearset.

10. The transfer case of claim 1,
wherein the transfer case has a neutral operating mode,
wherein, in the neutral operating mode:
the carrier shift collar and the shift plunger are each in a disconnected state,
wherein torque does not transfer between the first output shaft and the torque multiplying gearset in response to rotation of the first output shaft,
wherein torque does not transfer between the first output shaft and the input shaft in response to rotation of the first output shaft.

11. The transfer case of claim 10,
wherein the transfer case has a generator operating mode,
wherein, in the generator operating mode:
the carrier shift collar and the shift plunger are each in a disconnected state;
the input clutch is in a connected state;
wherein torque form the input shaft transfers to the electric motor via the input clutch;
wherein torque does not transfer from the torque multiplying gearset to the first output shaft;
wherein torque does not transfer from the input shaft to the first output shaft.

12. The transfer case of claim 11,
wherein the transfer case has an electric operating mode,
wherein, in the electric operating mode:
the carrier shift collar is in a connected state;
the shift plunger is in a disconnected state;
the input clutch is in a disconnected state;
wherein the electric motor applies torque to the rotor shaft;
wherein torque from the rotor shaft is multiplied by the torque multiplying gearset and transferred to the first output shaft via the carrier shift collar.

13. The transfer case of claim 12,
wherein the transfer case has a first hybrid operating mode,
wherein, in the first hybrid operating mode:
the carrier shift collar is in a connected state;
the shift plunger is in a disconnected state;
the input clutch is in a connected state;
wherein torque from the input shaft is transferred to the rotor shaft via the input clutch;
wherein the electric motor applies torque to the rotor shaft;
wherein the torque from the input shaft and the electric motor define a combined torque at the rotor shaft;
wherein the combined torque is multiplied by the torque multiplying gearset and transferred to the first output shaft via the carrier shift collar.

14. The transfer case of claim 13,
wherein the transfer case has a second hybrid operating mode,
wherein, in the second hybrid operating mode:
the carrier shift collar is in a connected state;
the shift plunger is in a connected state;
the input clutch is in a disconnected state;
wherein torque from the input shaft is transferred to the shift plunger via the mainshaft;
wherein the electric motor applies torque to the rotor shaft;
wherein the torque of the rotor shaft is multiplied by the torque multiplying gearset and defines a multiplied torque at the carrier shift collar;
wherein the torque of the shift plunger and the multiplied torque are combined at the first output shaft via the shift plunger and the carrier shift collar.

15. The transfer case of claim 14,
wherein the transfer case has a conventional operating mode,
wherein, in the conventional operating mode:
the carrier shift collar is in a disconnected state;
the shift plunger is in a connected state;
the input clutch is in a disconnected state;
wherein torque from the input shaft is transferred to the shift plunger via the mainshaft;
wherein the torque of the shift plunger is transferred to the first output shaft.

16. The transfer case of claim 1, wherein the torque multiplying device is a planetary gearset including a carrier, wherein the carrier is selectively engaged by the carrier shift collar, wherein the rotor shaft includes a sun gear of the planetary gear set and drives the planetary gear gearset in response to rotation.

17. A motor vehicle, comprising:
a primary power source;
a primary driveline including a set of primary wheels;
a secondary driveline including a set of secondary wheels;
a transfer case including a secondary power source in the form of an electric motor, wherein the electric motor includes a rotor shaft coupled to a torque multiplying gearset;
an input shaft of the transfer case that receives power from the primary power source;
a mainshaft fixed for rotation to the input shaft;
a first output shaft that delivers drive torque from the primary power source and the secondary power source to the first driveline;
a selectably controllable input clutch assembly disposed between the input shaft and the rotor shaft for connecting and disconnecting the input shaft to the rotor shaft;
a mode selector assembly including a carrier shift collar and a shift plunger which are independently axially moveable relative to each other, wherein the mode selector assembly is coaxial with the first output shaft and rotates with the first output shaft;
wherein the carrier shift collar selectably connects and disconnects the torque multiplying gearset to the first output shaft and wherein the shift plunger selectably connects and disconnects the mainshaft to the first output shaft;
a control system for controlling said electric motor, actuation of the controllable clutch assembly, actuation of the input clutch assembly, and actuation of the mode selector assembly to provide different driving modes.

18. The motor vehicle of claim 17, further comprising:
a second output shaft that delivers drive torque to the second driveline from the first output shaft;
a controllable clutch assembly positioned between the first and second output shaft;
a power transferring device connecting the first output shaft and the controllable clutch assembly;
wherein, when the controllable clutch assembly is in a connected state, torque transfers between the first output shaft and the second output shaft via the power transferring device.

19. The motor vehicle of claim 17, wherein the input clutch assembly includes an input clutch with clutch teeth, wherein the input clutch is fixed for rotation with the input shaft and axially moveable relative to the input shaft, wherein the input clutch is actuatable into engagement with rotor clutch teeth of the rotor shaft, wherein torque transfers from the input shaft to the rotor shaft when the input clutch assembly is connected.

20. The motor vehicle of claim 17,
wherein the carrier shift collar is rotationally fixed with the first output shaft and axially moveable along the first output shaft;
wherein the shift plunger is rotationally fixed with the carrier shift collar and axially moveable along the carrier shift collar;
wherein the carrier shift collar is independently actuatable into engagement with teeth of a carrier portion of the torque multiplying device and transfers torque from the rotor shaft when connected;
wherein the shift plunger is independently actuatable into engagement with teeth of flange portion of the mainshaft and transfers torque from the mainshaft when connected;
wherein the shift plunger includes a lug portion extending through apertures formed in the carrier shift collar.
